(19) United States
(12) Patent Application Publication
(10) Pub. No.: US 2007/0254072 A1
(43) Pub. Date: Nov. 1, 2007

(54) Water-in-Oil Emulsion

(75) Inventor: Franciscus Maria Josephus Cleophas, Zetten (NL)

Correspondence Address: HOFFMANN & BARON, LLP, 6900 JERICHO TURNPIKE, SYOSSET, NY, 11791, US

(73) Assignee: Smartfood Techonolgy B.V.

(21) Appl. No.: 11/597,183

(22) PCT Filed: May 24, 2005
(86) PCT No.: PCT/NL05/00383

§ 371 Date: Jan. 3, 2007

(30) Foreign Application Priority Data
May 26, 2004 (NL) 1026267

(51) Int. Cl. A23D 7/00; B65D 85/00

(52) U.S. Cl. 426/106; 426/602

(57) ABSTRACT

The present invention relates to a water-in-oil emulsion, in particular in the form of a sauce or soup, the emulsion at least comprising: a water phase; a fat phase; an emulsifier; optionally one or more weak acids or derivatives thereof in the form of a food acid or an acidity regulator, the emulsion having a pH of 4.6 or higher, and the emulsion being suitable for introducing into a packaging in the cold state. The weak acids or derivatives thereof, preferably selected from the group consisting of lactic acid, citric acid, malic acid and acetic acid, are used as the food acid or acidity regulator.

The present invention relates to a water-in-oil emulsion, in particular in the form of a sauce or soup.

The person skilled in the art will understand what is meant by a water-in-oil emulsion, and consequently this term requires no further explanation here. It should be noted, however, that a distinction needs to be drawn (and can be drawn in technical terms) between a water-in-oil emulsion and an oil-in-water emulsion. Water-in-oil emulsions are generally used to produce margarines, spreads and fats. Inter alia JP 09025493 and JP 09235584 are known in the prior art. These publications relate to emulsified fats, which differ from a sauce in terms of technology, use and viscosity.

A general feature of a sauce or a soup is that they can be used as stand-alone meal components, beverages, snacks or desserts.

In the case of sauces, consideration may, of course, be given to savoury sauces forming part of the main meal, such as tomato sauce or béchamel sauce, but also to sweet and/or dairy-based sauces, such as vanilla custard and fruit-flavour soft curd cheese, or to a sauce based on, for example, fruit puree.

In the case of soups, consideration may be given to savoury soups, such as curry soup or cream of chicken soup, but also to gravy or to beverages, such as chocolate drink or a dairy drink based, for example, on buttermilk.

The invention applies both to products which can be stored at ambient temperature and to products which are stored at refrigerated temperatures.

If unrefrigerated storage is desired, in the case of the known soups and sauces the preservation method opted for is generally sterilization of the soup or sauce in the packaging or alternatively introduction of the soup or sauce into the packaging in the warm state. The prior art includes, inter alia, the disclosure WO 02/05659, in which the technique of filling packaging with warm product is described with reference to examples.

One major drawback of filling the packaging with the product in the warm state is the fact that the product remains warm for a long period of time in the packaging, which leads to a typical “boiled flavour”, a product which looks unappetizing or even to product segregation.

Other known sauces are preserved by using a high acidity (i.e. a low pH), in which case use is generally made of an acidity regulator system which comprises a single acid if appropriate together with its own salt. For example, in some sauces use is made of lactic acid together with sodium lactate; in other sauces, use is made of acetic acid and if appropriate sodium acetate. By definition, these sauces have a pH range of 4.6 or below. These sauces can be introduced into the packaging in the cold state without the product having to be sterilized in the packaging. The prior art includes, inter alia, WO 92/07474, U.S. Pat. No. 4,840,806 and JP 05207886, which describe pH ranges of between 3.5 and 4.5 in combination with the cold packaging technique.

One significant drawback of preserving sauces in this way (and this method can also be applied to soups) is that sauces preserved in this way often taste acidic, which is generally caused by the acidity regulator system which is used to preserve the sauces (or soups). It has been found that the consumer is not particularly fond of acidic tastes of this nature.

Sweet sauces are often stored in the refrigerator in order to guarantee their shelf life (for example pasteurized vanilla custard) or alternatively can be stored outside the refrigerator (for example UHT-treated drinking yoghurt). One significant drawback of the pasteurized product is the very limited shelf life even if the product is stored in the refrigerator.

Another known form of known soups and sauces with a long shelf life is sauces and soups which are packaged in concentrated or dried form.

One drawback of sauces and soups in dried form is that they still have to be diluted with water by the user himself, which is considered a laborious operation. Moreover, in practice it has been found that it is sometimes difficult to add the correct quantity of water to the dried soup or sauce and that it is not always possible to prevent lumps from forming.

One example of a soup in concentrated form is disclosed in the prior art, for example, in GB 113507070, which describes a concentrated soup to which hot water is added prior to use. Users may consider this a laborious operation. The ready-to-use emulsion according to the invention is easy to use and has a long shelf life and merely has to be warmed prior to use, if desired. Therefore, it is not necessary for the sauce also to be mixed with water, for example, which is of benefit to its ease of use.

It is an object of the present invention to avoid one of the problems mentioned above or other problems.

A further object of the present invention is to provide a new, preferably ready-to-use water-in-oil emulsion, in particular in the form of a soup or sauce (sweet or savoury), with a good shelf life while at the same time guaranteeing a pleasant flavour profile.

One or more of the above or other objects are achieved, according to the present invention, by a water-in-oil emulsion, in particular in the form of a sauce or soup, the emulsion at least comprising:
a water phase;
a fat phase;
an emulsifier;
optionally a food acid or an acidity regulator in the form of one or more weak acids or derivatives thereof; the emulsion having a pH of 4.6 or higher, and the emulsion being suitable for being poured into the packaging cold.

Surprisingly, it has been found that the emulsion according to the present invention gives a greatly improved shelf life both for products stored at refrigerator temperatures and for products which can be kept outside the refrigerator, such as ready-to-use sauces and soups, while at the same time also producing a greatly improved, less acidic flavour.

Without wishing to be tied to any particular theory, it is the Applicant's opinion that this improved shelf life is attributable to the use of what is described in the specialist field as an “invert emulsion”, namely a water-in-oil emulsion, instead of the oil-in-water emulsion which is customary for this type of product. Normal commercially available sauces and soups as described herein are in the form of oil-in-water emulsions. The prior art includes, inter alia, EP 0414024, EP 09098728 and JP 09023844, which describes the use of this type of oil-in-water emulsions.

One particular advantage of the emulsion according to the present invention is that it does not need to be subjected to a sterilization step in the packaging. Also, the emulsion does not have to be introduced into the packaging in a warm state. It has been found that this is of benefit to the appearance and flavour of the sauce or soup obtained. Furthermore, it has been found that no specific barrier demands need to be imposed on the packaging or packaging environment used. For example, there is no need to use aseptic forms of packaging, as described in EP 0832566 and WO 02/05659.

Moreover, it has been found that the emulsion has a surprisingly long microbiological shelf life in a closed packaging both in the case of refrigerated and unrefrigerated storage. In the case of unrefrigerated storage, it was found that the emulsion could be stored in a sealed packaging for longer than twelve months while nevertheless being able to guarantee its microbiological shelf life.

A further advantage is that according to the invention it is possible to generate completely new flavour profiles, in many cases with a surprisingly mild flavour.

The water-in-oil emulsion according to the present invention comprises a water phase, which is intended to impart a certain liquidity to the emulsion, so that it can more easily be poured over a food product which is to be garnished, such as vegetables or meat, can be eaten as a soup or is directly suitable in some other way for its intended use as a stand-alone meal component, a snack, a dessert or as a beverage.

In addition to water, the water phase may comprise further components, such as herbs, binders, flavours, flavourings, colours, etc.

The fat phase may comprise one or more oils or fats as are used in the food industry.

The emulsifier used may likewise be emulsifiers which are known in the food industry.

Sorbic acid or benzoic acid can be used as additional preservatives, in their free acid form or their salt form, or a combination thereof. However, other preservative components are also possible. In this context, it should also be noted that it is not necessary to add the sorbic acid and/or benzoic acid referred to as preservative to enable the desired shelf life to be guaranteed, especially if the emulsion has a pH of higher than 4.6.

The acidity regulator which is used according to the invention in one embodiment comprises at least one weak acid, in its free form or its derivative form (salt). For example, the acid may consist of citric acid, lactic acid or acetic acid. It is also possible for other acids to be used.

In the specialist field, a weak acid is generally defined as an acid which does not fully dissociate into a proton and its conjugate base in water.

In another embodiment, the acidity regulator used comprises at least two different weak acids, in the free acid form or derivative form thereof. By way of example, the acidity regulator may comprise citric acid in combination with lactate (i.e. the salt derivative of lactic acid). The person skilled in the art will quickly understand that the acidity regulator may also comprise further components.

In this context, it should also be noted that an acid which may be present as preservative, such as sorbic acid or benzoic acid (or derivatives thereof), in the context of the present invention is not considered to be a food acid or an acidity regulator.

According to a preferred embodiment of the emulsion according to the invention, preferably if unrefrigerated storage is desired, it is opted to use at least one of the weak acids or derivatives selected from the group consisting of lactic acid, citric acid or malic acid or acetic acid. In a further preferred embodiment of the emulsion according to the invention, it is opted to use at least two of the weak acids or derivatives thereof selected from the group consisting of lactic acid, citric acid, malic acid and acetic acid. In this case, it is preferable for the acidity regulator to comprise at least a combination of acids or derivatives thereof selected from: citric acid and lactic acid; malic acid and lactic acid; citric acid, malic acid and lactic acid; lactic acid and acetic acid; citric acid, lactic acid and acetic acid; malic acid, lactic acid and acetic acid; and citric acid, malic acid, lactic acid and acetic acid. It has been found that it is in this way possible to obtain an improved shelf life in combination with a mild flavour profile.

Highly desirable flavour profiles are obtained if the emulsion comprises 0.01-1.0% by volume of citric acid and 0.10-1.0% by volume of lactic acid, preferably 0.02-0.50% by volume of citric acid and 0.02-0.50% by volume of lactic acid, based on the emulsion.

Favourable flavour profiles are also obtained if the emulsion comprises 0.01-0.10% by volume of malic acid and 0.01-1.0% by volume of lactic acid, preferably 0.02-0.50% by volume of malic acid and 0.02-0.50% by volume of lactic acid, based on the emulsion.

Furthermore, it is preferable if the emulsion comprises 0.01-1.0% by volume of citric acid, 0.01-1.0% by volume of malic acid and 0.01-1.0% by volume of lactic acid, preferably 0.02-0.50% by volume of citric acid, 0.02-0.50% by volume of malic acid and 0.02-0.50% by volume of lactic acid, based on the emulsion.

It is also favourable if the emulsion comprises 0.01-1.0% by volume of lactic acid and 0.01-1.0% by volume of acetic acid, preferably 0.02-0.50% by volume of lactic acid and 0.02-0.50% by volume of acetic acid, based on the emulsion.

According to an alternative preferred embodiment, the emulsion comprises 0.01-1.0% by volume of citric acid, 0.01-1.0% by volume of lactic acid and 0.01-1.0% by volume of acetic acid, preferably 0.02-0.50% by volume of citric acid, 0.02-0.50% by volume of lactic acid and 0.02-0.50% by volume of acetic acid, based on the emulsion.

According to another alternative embodiment, the emulsion comprises 0.01-1.0% by volume of malic acid, 0.01-1.0% by volume of lactic acid and 0.01-1.0% by volume of acetic acid, preferably 0.02-0.50% by volume of malic acid, 0.02-0.50% by volume of lactic acid and 0.02-0.50% by volume of acetic acid, based on the emulsion.

Furthermore, it is preferable if the emulsion comprises 0.01-1.0% by volume of citric acid, 0.01-1.0% by volume of malic acid, 0.01-1.0% by volume of lactic acid and 0.01-1.0% by volume of acetic acid, preferably 0.02-0.50% by volume of citric acid, 0.01-0.50% by volume of malic acid, 0.02-0.50% by volume of lactic acid and 0.02-0.50% by volume of acetic acid, based on the emulsion.

According to the present invention, the emulsion has a pH in the range from 4.6-7.5, preferably 4.8-7.0, even more preferably 4.8-6.5. If exclusively unrefrigerated storage is desired, within this pH range it is preferable to use a pH from 4.6-5.8, more preferably 4.8-5.5.

If the intention is for the sauce or soup to be stored at refrigerated temperatures, within the abovementioned range of 4.6-7.5 it is preferable to opt for a pH of 4.8-7.0, even more preferably a pH of 4.8-6.5.

This can guarantee a very good shelf life for the sauce.

Furthermore, it has proven expedient, in order to obtain a desired texture of the emulsion, for the water phase to form 5-99% by volume, preferably 50-95% by volume, more preferably 60-90% by volume, of the sauce.

Furthermore, according to the present invention it is preferable for the emulsion to have an AW value of 0.60-1.00, preferably 0.80-0.98. The “AW value” is a variable which is known per se in the specialist field and can be used as an indicator for estimating the shelf life of products. It is generally the case that products with a low AW value have a good shelf life. The use of, for example, an increased quantity of salt or sugars in a product lowers the AW value and thereby improves the shelf life of a product. The prior art discloses, in XP 002308828 and the above-referenced WO 02/05659, examples describing the use of increased quantities of salt and sugars. Obviously, these increased quantities of salt and sugars influence the flavour of the product. The present invention makes it possible to form products with an AW value which, purely on the basis of this AW value, is suitable for the growth of micro-organisms, yet a good shelf life can nevertheless be guaranteed.

The AW value can be determined, for example, with the aid of an instrument customarily used for this purpose, known as the Novisana 2000 (available from Pedak, Heythuijsen, The Netherlands).

The emulsion according to the present invention can be prepared by simply mixing the components. It is preferable for the mixed components to be heated to a temperature of 50-150° C., preferably 50-130° C., after which the emulsion is cooled back down to a temperature of 0-55° C. Then, the emulsion can be introduced into the desired packaging. More preferably, the emulsion is heated to a temperature of 65-110° C., in particular 80-95° C., after which the emulsion is cooled back down to a temperature of 0-55° C.

It is preferable for the emulsion to be introduced into the packaging in the cold state, i.e. at a temperature of <55° C., preferably <40° C.

Furthermore, it is of benefit to the flavour and appearance of the emulsion if the emulsion is not sterilized in the packaging.

A further aspect of the present invention relates to a packaging provided with the emulsion according to the invention. The packaging is generally made from plastic or glass.

The invention will be explained in more detail below on the basis of a number of non-limiting examples.

### EXAMPLE 1

A quantity of 100 kg of emulsion in the form of a sauce forming part of a main meal was prepared by mixing the following ingredients:
67.711 kg of water;
12.900 kg of fat phase with emulsifier (Eureka; [main constituents: palm oil and fractions of palm oil, emulsifier], obtained from Cleophas foodsolutions, Zetten, The Netherlands);
0.050 kg of citric acid (obtained from Chemproha, Enschede, The Netherlands);
0.300 kg of lactic acid 50% (Chemproha);
2.340 kg of sodium lactate 60% (Chemproha);
0.800 kg of cooking salt;
8.500 kg of sugar;
3.500 kg of corn starch (obtained from Amylum, Aalst, Belgium);
4.500 kg of mix for Bechamel sauce (obtained from Unifine, Puttershoek, The Netherlands).

The ingredients were mixed for 5 minutes at 70° C. in a Nauta mixer (available from Hosakawa Micron, Doetinchem, The Netherlands). Then, the sauce was heated to a temperature of approx. 90° C. with the aid of a Gerstenberg heat exchanger (available from Gerstenberg & Agger, Brondby, Denmark). After that, the sauce was cooled to a temperature of 15° C.

The sauce had a pH of 5.2 and an AW value of approx. 0.98. The result was an attractive sauce with a mild flavour and a good microbiological stability.

### EXAMPLE 2

A quantity of 100 kg of sauce forming part of a main meal was prepared by mixing the following ingredients:
69.215 kg of water;
12.000 kg of fat phase with emulsifier (Eureka; Cleophas foodsolutions);
0.060 kg of citric acid (Chemproha);
0.025 kg of malic acid (Chemproha);
0.400 kg of lactic acid 50% (Chemproha);
0.800 kg of cooking salt;
8.500 kg of sugar;
3.000 kg of corn starch (Amylum);
6.000 kg of mix for Bechamel sauce (Unifine).

The ingredients were mixed for 5 minutes at 70° C. in a Nauta mixer. Then, the sauce was heated to a temperature of approx. 75° C. with the aid of a Gerstenberg heat exchanger. After that, the sauce was cooled to a temperature of 18° C.

The sauce had a pH of 5.1 and an AW value of approx. 0.98. The result was an attractive sauce with a mild flavour and a good microbiological stability.

### EXAMPLE 3

A quantity of 100 kg of tomato soup was prepared by mixing the following ingredients;
35.800 kg of water;
15.000 kg of tomato juice (obtained from Riedel, Ede, The Netherlands);
30.000 kg of fat phase with emulsifier (Eureka; Cleophas foodsolutions);
0.030 kg of malic acid (Chemproha);
0.151 kg of lactic acid 50% (Chemproha);
1.890 kg of sodium lactate 60% (Chemproha);
0.400 kg of cooking salt;
10.400 kg of base mix for tomato soup ([flavourings, stock powder, sugar, milk protein], Unifine);
2.500 kg of corn starch (Amylum).

The ingredients were mixed for 5 minutes at 70° C. in a Nauta mixer. Then, the soup was heated to a temperature of approx. 130° C. with the aid of a Gerstenberg heat exchanger. After that, the soup was cooled to a temperature of 12° C. and introduced into the packaging. The soup had a pH of 4.9 and an AW value of approx. 0.98. The result was an attractive soup with a mild flavour and a good microbiological stability.

1. Water-in-oil emulsion, in particular in the form of a sauce or soup, the emulsion at least comprising:
a water phase;
a fat phase;
an emulsifier;
optionally a food acid or an acidity regulator in the form of one or more weak acids or derivatives thereof;
the emulsion having a pH of 4.6 or higher, and the emulsion being suitable for being poured into the packaging cold, where in the waterphase forms from 60-99% by volume and wherein the emulsion has an AW value of 0.60-1.00.

2. Emulsion according to claim 1, in which the food acid or the acidity regulator comprises at least one weak acid in the free acid form or the derivative form thereof, or comprises two different weak acids in the free form or derivative form thereof, the weak acids or derivatives thereof being selected from the group consisting of lactic acid, citric acid, malic acid and acetic acid.

3. Emulsion according to claim 2, in which the acidity regulator comprises at least a combination of acids or derivatives thereof which is selected from: citric acid and lactic acid; malic acid and lactic acid; citric acid, malic acid and lactic acid; lactic acid and acetic acid; citric acid, lactic acid and acetic acid; malic acid, lactic acid and acetic acid; and citric acid, malic acid, lactic acid and acetic acid.

4. Emulsion according to claim 1 claims, the emulsion having a pH in the range from 4.6-7.5, preferably 4.8-7.0, even more preferably 4.8-6.5.

5. (canceled)

6. Emulsion according to claim 1, which has an AW value of 0.80-0.98.

7. Use of the emulsion according to claim 1 as a soup.

8. Use of the emulsion according to claim 1 as a sauce.

9. Packaging provided with emulsion according to claim 1, which packaging is not suitable for filling under aseptic conditions.

10. Packaging according to claim 9, in which the emulsion is introduced into the packaging in a cold state.

11. Packaging according to claim 9, in which the emulsion is not sterilized in the packaging.
